(19) United States
(12) Patent Application Publication
(10) Pub. No.: US 2018/0305119 A1
(43) Pub. Date: Oct. 25, 2018

(54) WASTE DISPOSAL ENCLOSURE WITH SOLID RETRACTABLE WALLS

(71) Applicant: RAD SOLUTIONS, L.L.C., Schleswig, IA (US)

(72) Inventors: Steven Struck, Schleswig, IA (US); Clinton Vos, Lawton, IA (US)

(21) Appl. No.: 15/495,310

(22) Filed: Apr. 24, 2017

(51) Int. Cl. B65F 1/14; E06B 3/46; E06B 5/00; E05F 15/60; E05F 15/77; E05F 17/00

(52) U.S. Cl. CPC B65F 1/1426; E06B 3/46; E06B 5/00; E05F 15/60; E05Y 2900/604; E05F 17/002; E05Y 2201/434; E05F 2017/005; E05F 15/77

(57) ABSTRACT

An enclosure for waste material includes a movable front section and a stationary rear section. Movable intermediate sections may also be provided between the front and rear sections. Each section is formed by a frame with a rigid skin, with adjacent sections being sized so as to telescope with respect to one another. The front and any intermediate sections are rollable between an extended position to cover the waste material and a retracted position uncovering the waste material. A reversible electric motor may be actuated remotely or by a switch to open and close the enclosure. The enclosure protects the contents from the weather, from birds and other animals, and from unauthorized human access.

### FIELD OF THE INVENTION

The present invention relates generally to an expandable and collapsible enclosure to house waste material, such as food waste, biohazardous materials, animal carcasses, and other materials placed in a dumpster or otherwise left outdoors for later pick up by a waste removal service.

### BACKGROUND OF THE INVENTION

Many types of waste products, such as garbage, are often taken outside and placed in dumpsters or otherwise left on the ground for pickup by a garbage truck or other waste removal service. For example, restaurants, schools, and hospitals must dispose of leftover food on a daily basis. Hospitals medical clinics, and other industries have many types of waste or garbage, including biohazardous materials, which must be carefully handled for disposal.

Many establishments that use dumpsters for waste disposal have problems with other people throwing their waste or garbage into the dumpster. Some places put a fence around the dumpster in the hope of keeping others out. However, the fence does not stop people from throwing sacks of garbage over the top of the fence, or if the fence is not locked, from opening a gate to use the private dumpster. Also, sometimes the dumpster lid is left open, which then allows rain and snow into the dumpster, and allows animals, such as rats, raccoons, or vultures to get into the dumpster. All of these situations are undesirable from the perspective of the property owner. In the livestock and poultry industries, dead animals must be removed for disposal.

It is undesirable to leave the carcasses out in the open, which can lead to many issues, including spread of disease and undesirable odors. Therefore, there is a need for a waste material enclosure which overcomes the problems of the prior art.

Accordingly, a primary objective of the present invention is the provision of an enclosure for waste material which houses the waste until the waste is removed.

A further objective of the present invention is the provision of an enclosure for waste material dumpsters which keeps others from throwing waste and other garbage into the dumpsters without permission.

Another objective of the present invention is the provision of an enclosure which covers waste material for protection from the weather and from other animals.

A further objective of the present invention is the provision of a method of disposing of waste material by enclosing the material in a building or a structure having extendable and retractable walls and roof.

Still another objective of the present invention is the provision of a waste material enclosure having the plurality of arch-shaped telescoping sections which can be extended and retracted between closed and open positions.

A further objective of the present invention is the provision of an enclosure for waste material which can be opened and closed remotely to provide access to the material.

Yet another objective of the present invention is the provision of a waste material enclosure having motorized walls which can be rolled between an extended closed position and a retracted open position.

Still another objective of the present invention is the provision of an extendable and retractable waste material enclosure having rigid wall sections.

A further objective of the present invention is the provision of a waste material structure having nested wall and roof sections which can be extended to enclose the waste material and retracted to provide access to the waste material.

Another objective of the present invention is the provision of a waste material enclosure which can be accessed only by authorized personnel.

Still another objective of the present invention is the provision of a waste material enclosure which is economical to manufacture, and which is quick, easy, durable, and safe in use.

These and other objectives have become apparent from the following description of the invention.

### SUMMARY OF THE INVENTION

The waste material enclosure generally includes two or more arch-shaped sections forming the opposite walls and roof of the enclosure. The rear section is stationary, and the front section, and any intermediate sections, are movable between an extended closed position and a retracted open position. Preferably, each section is formed by a frame with a rigid skin, with the sections telescoping to and from one another. The opposite sides of the movable sections include rollers which rollably mount on opposite guide rails or tracks.

The front and intermediate sections can be moved manually, or alternatively, a reversible electric motor can be actuated to move the sections via a drive train. Remote control operation may also be provided.

The movable sections can be retracted to open the enclosure and thereby provide authorized access to the contents of the enclosure, such as a dumpster, an animal carcass, or other garbage and waste products. The moving section can then be extended to close the enclosure and thereby protect the contents from the weather, from varmint, and unauthorized people. A waste removal service can remotely actuate the motor to open the enclosure and thereby provide access to the contents for removal, all without exiting the waste removal truck.

In operation, the enclosure 10 can be moved between the closed position shown in FIG. 1 and the open position shown in FIG. 5. One or more dumpsters may be positioned within the base 18. Similarly, the base 18 may contain one or more animal carcasses, other waste containers, or material to be disposed. The front section 12 and intermediate sections 16 (if present) can be moved from the retracted open position to the extended closed position so as to cover the base 18. If desired, the sections 12, 16 can be locked against retraction to preclude unauthorized access into the enclosure 10. When a waste recovery person comes to collect the waste, the sections 12, 16 can be retracted to uncover the base 18. Then, the waste recovery person can remove the waste from inside the base 18, and then close the sections 12, 16.

For example, a restaurant, school, hospital, or other institution can put food and other waste in one or more dumpsters within the enclosure 10. A garbage truck driver can remotely actuate the motor 40 to open the enclosure 10, then drive up to the base 18, and then pick up and empty the dumpster with conventional garbage truck arms. The dumpster can then be reset inside the base 18, and the driver can close the enclosure before leaving the site. Thus, the truck driver can do his/her job without exiting the truck.

Thus, the enclosure 10 provides environmental protection to the waste material, keeps out unwanted animals and people, and hides the waste material and garbage from people passing by.

These and other objectives will become apparent from the following description of the invention.

### BRIEF DESCRIPTION OF THE DRAWINGS

FIG. 1 is a perspective view of the waste material enclosure of the present invention in an extended, closed position.

FIG. 2 is a side elevation view of the closed enclosure.

FIG. 3 is a top plan view of the closed enclosure.

FIG. 4 is a front elevation view of the enclosure.

FIG. 5 is a perspective view of the enclosure in a retracted open position, and showing an alternative solar panel power source.

FIG. 6 is a side elevation view of the opened enclosure.

FIG. 7 is a top plan view of the opened enclosure.

FIG. 8 is a perspective view of the front section of the enclosure.

FIG. 9 is a front elevation view of the front section.

FIG. 10 is a perspective view of an intermediate section of the enclosure.

FIG. 11 is a front elevation view of the intermediate section.

FIGS. 12 and 13 are elevation views of the intermediate section from opposite sides.

FIGS. 14 and 15 are perspective views of the lock mechanism for the enclosure.

FIGS. 16 and 17 are perspective views of one of the idler roll assemblies for the enclosure sections.

FIG. 18 is a perspective view of the latch for the enclosure.

FIG. 19 is a perspective view of the latch release lever for the enclosure.

FIG. 20 is a perspective view of a front corner of the enclosure showing the latch and latch release lever.

FIG. 21 is another perspective view showing a portion of the roller guide tracks for the enclosure.

FIG. 22 is a perspective view showing a motor and drive train for the enclosure.

FIG. 23 is a schematic view showing a portion of the enclosure drive train.

FIG. 24 shows the drive train with the enclosure closed.

FIG. 25 shows the drive train with the enclosure open.

### DETAILED DESCRIPTION OF THE PREFERRED EMBODIMENTS

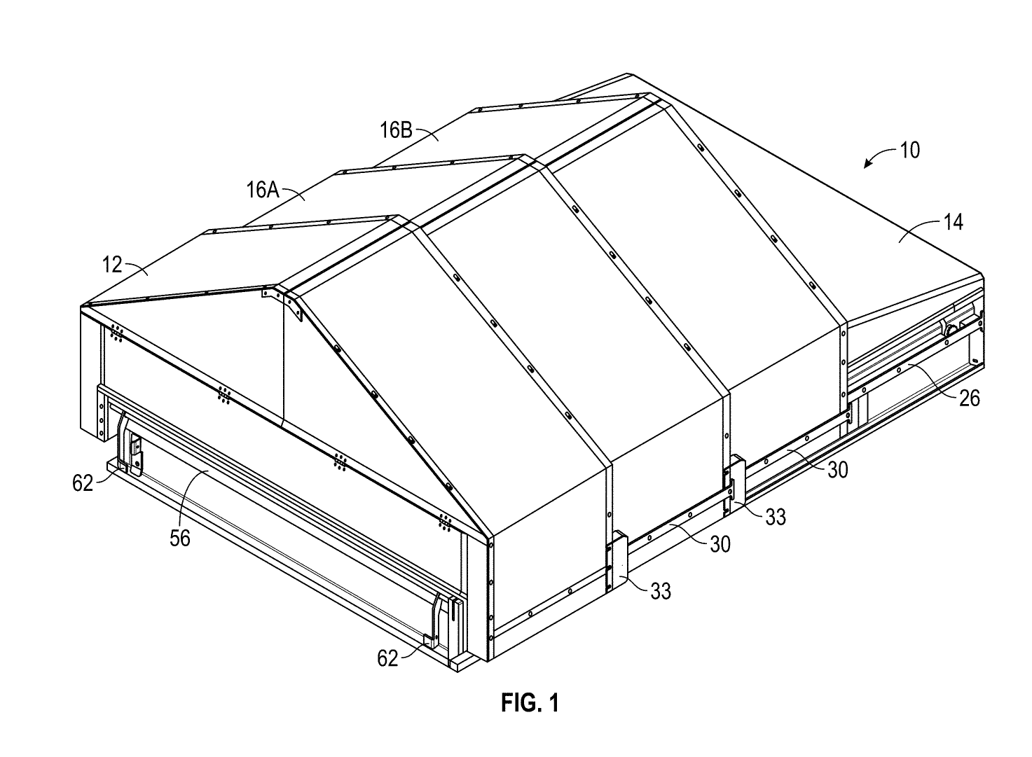

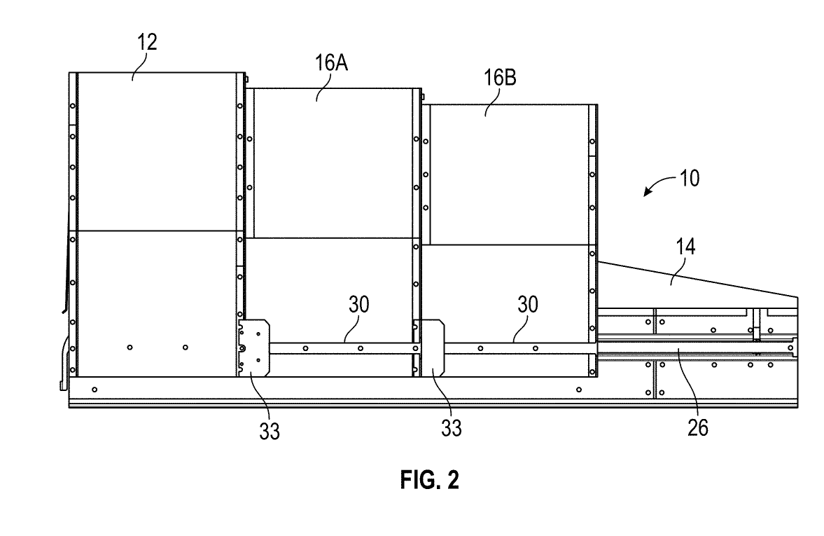

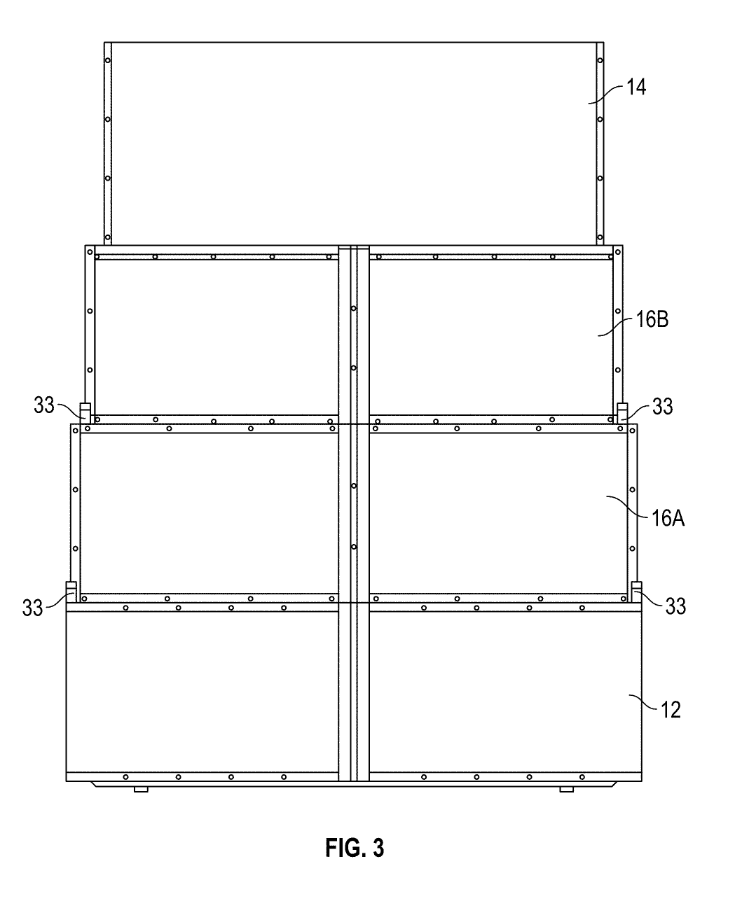

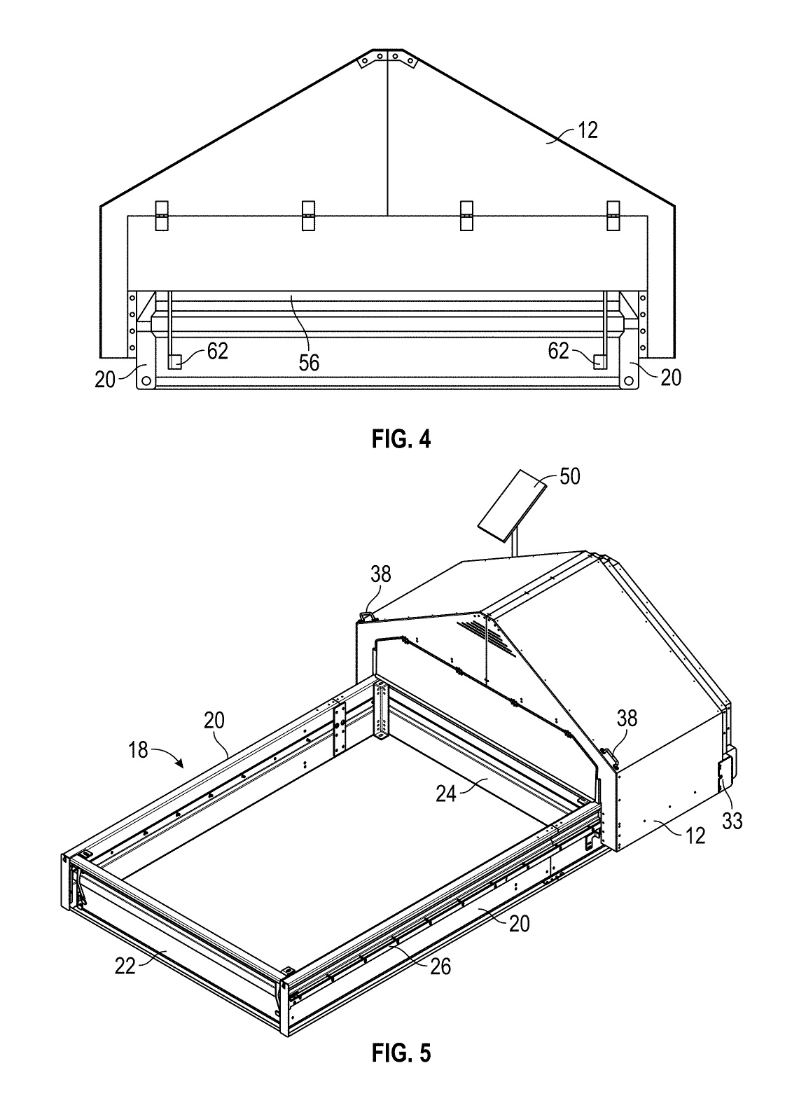

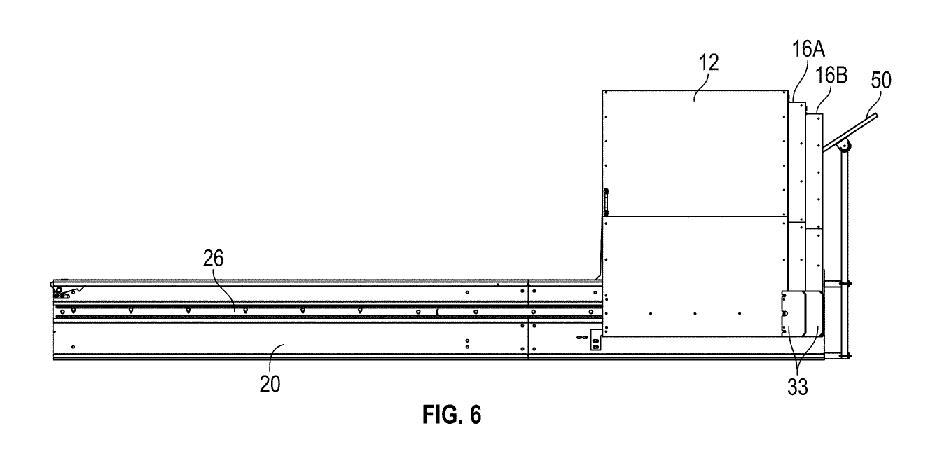

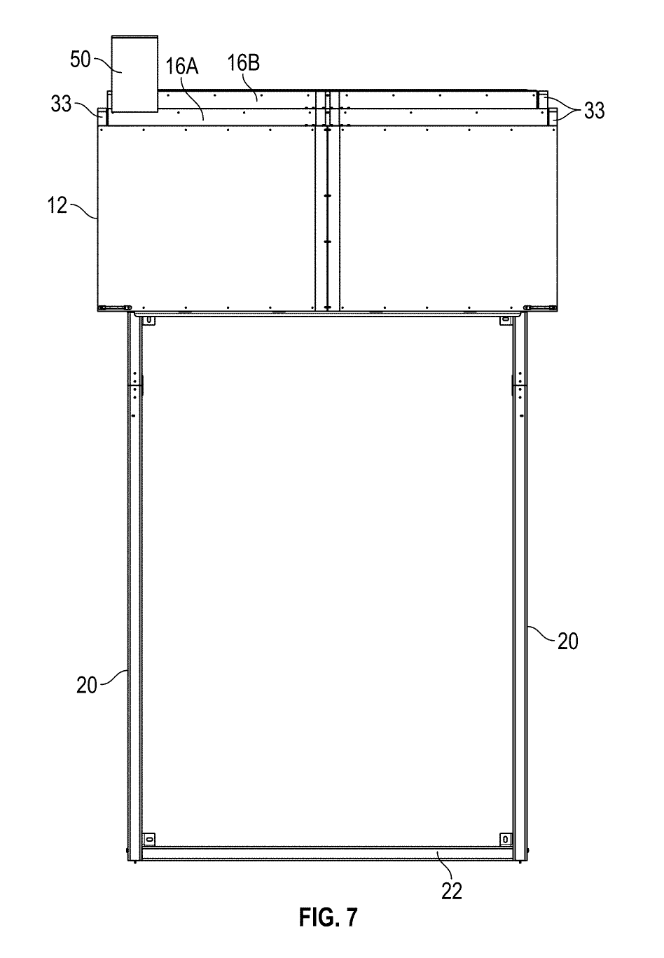

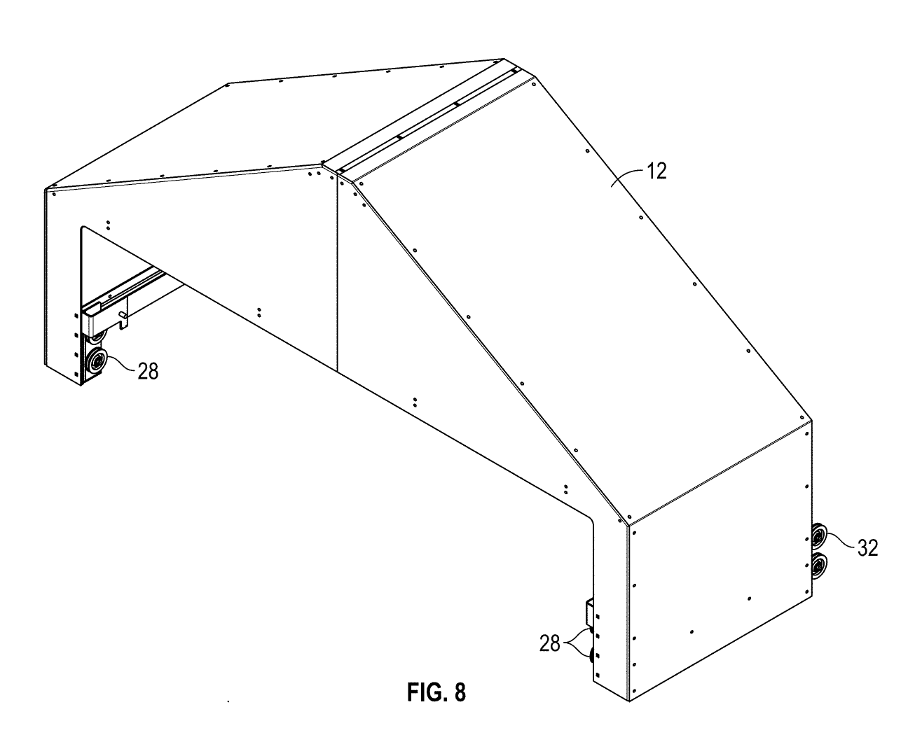

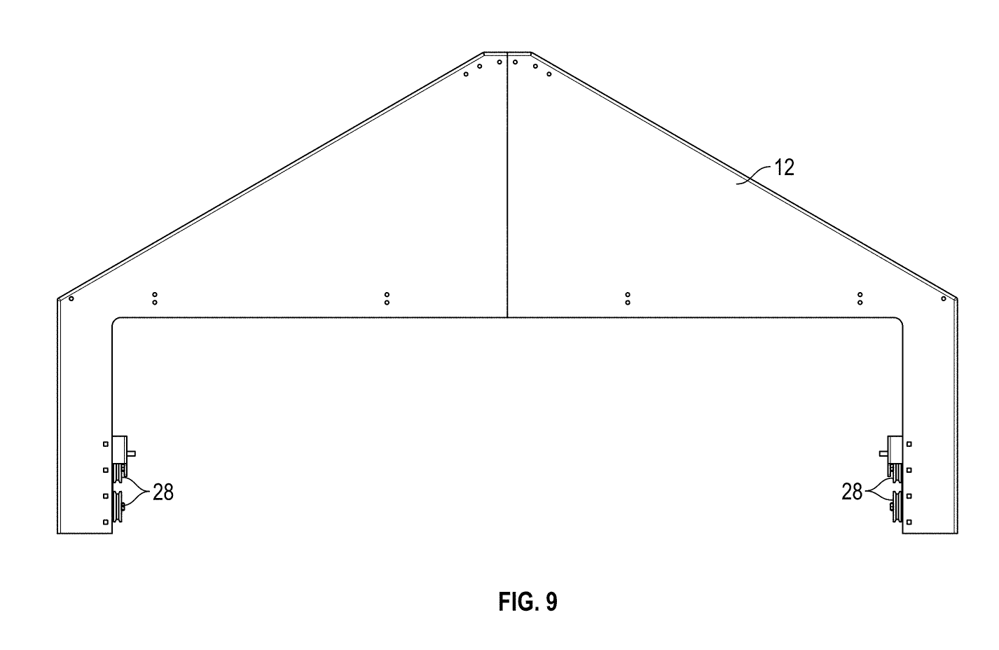

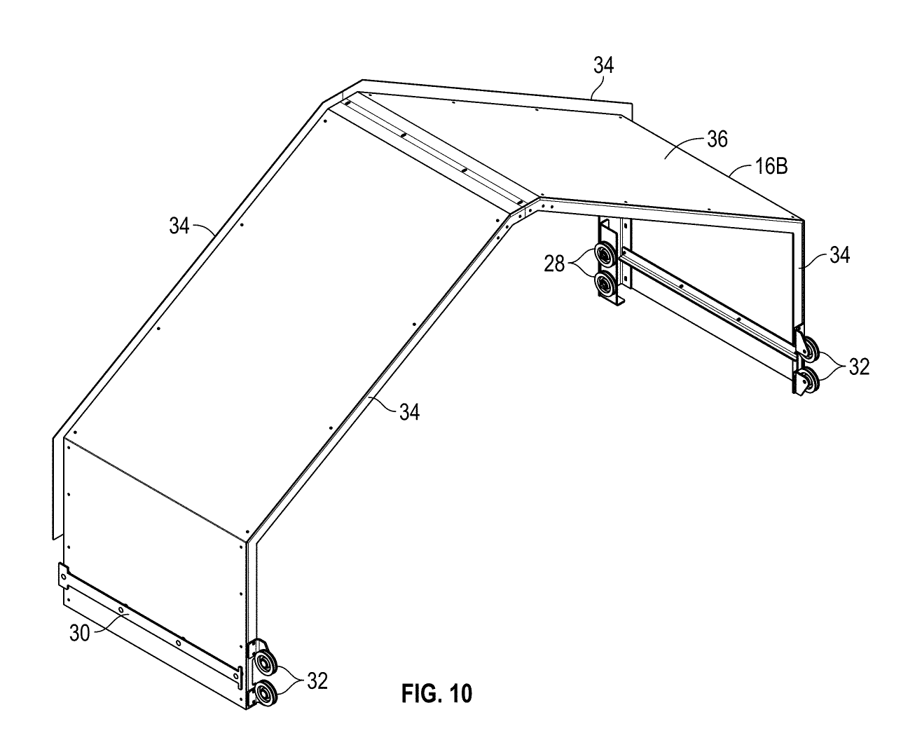

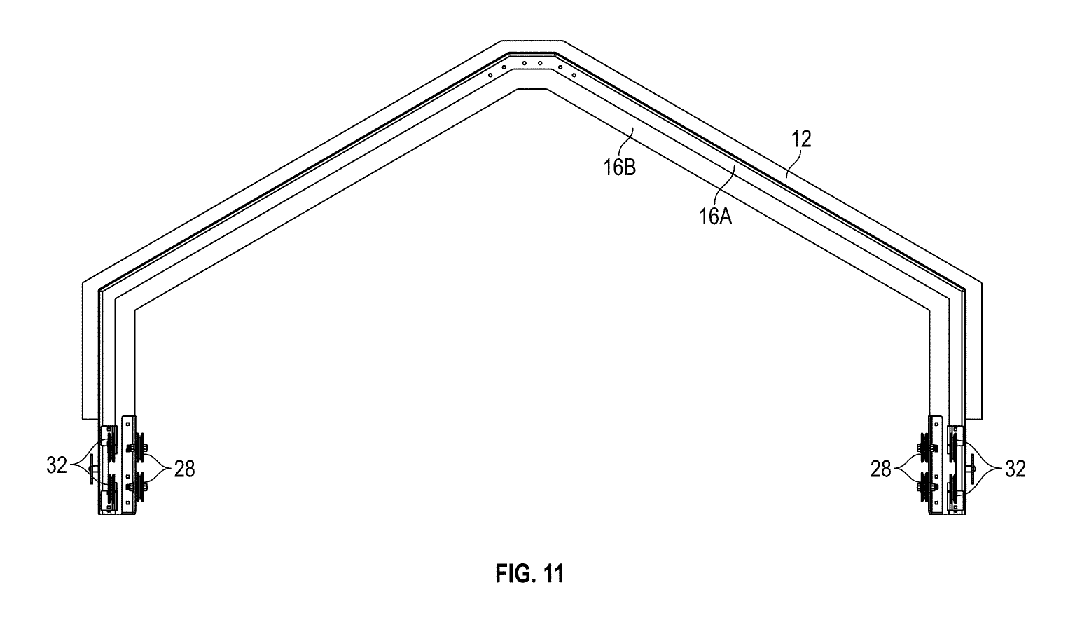

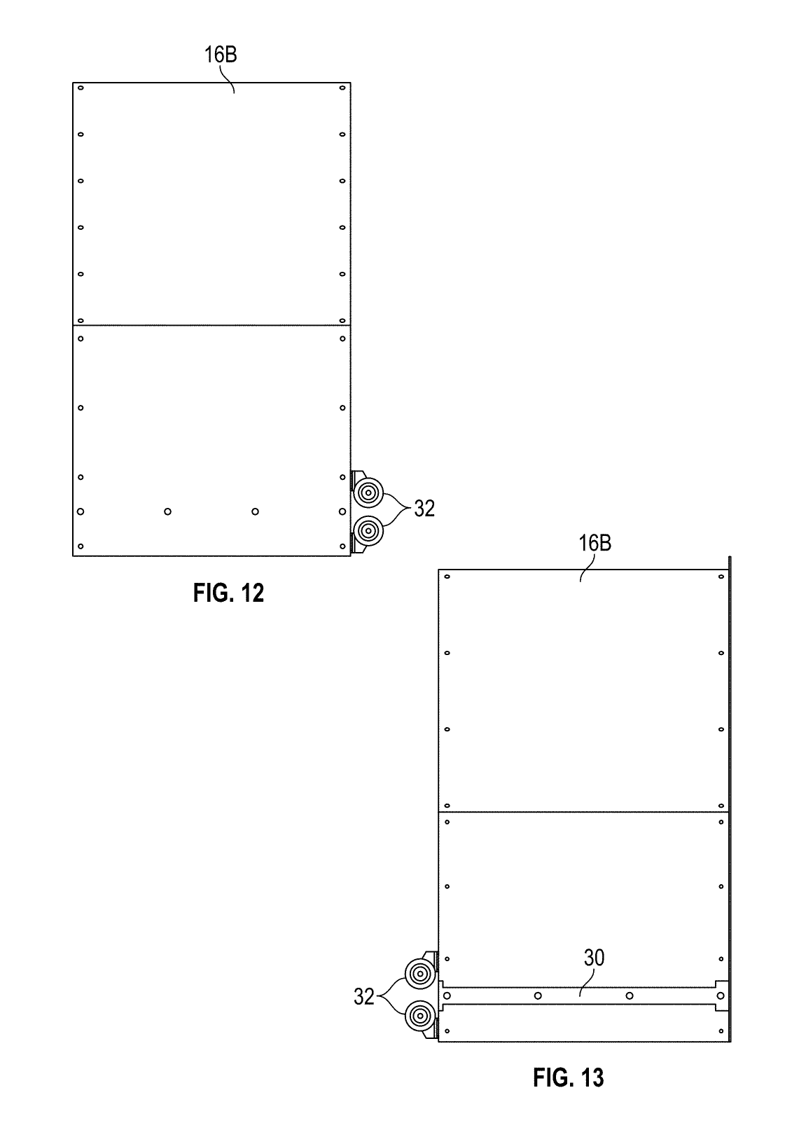

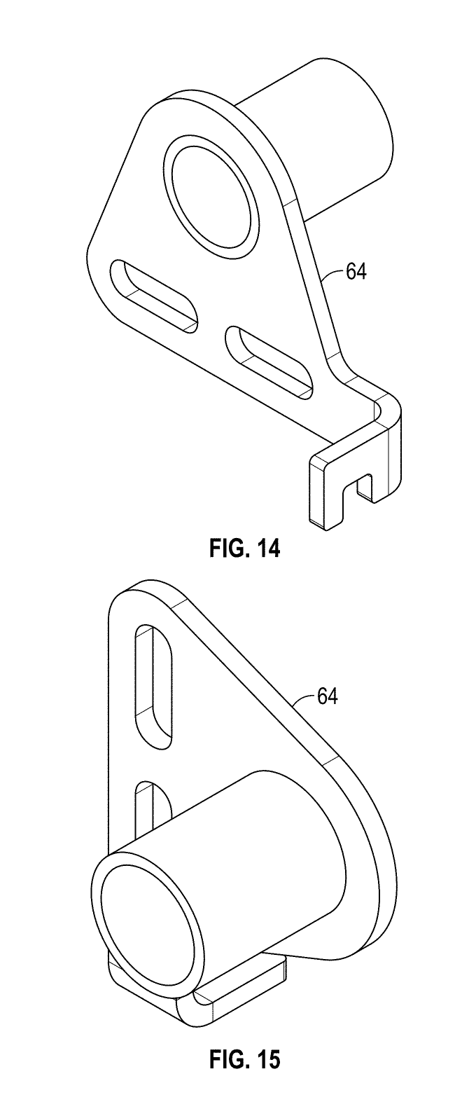

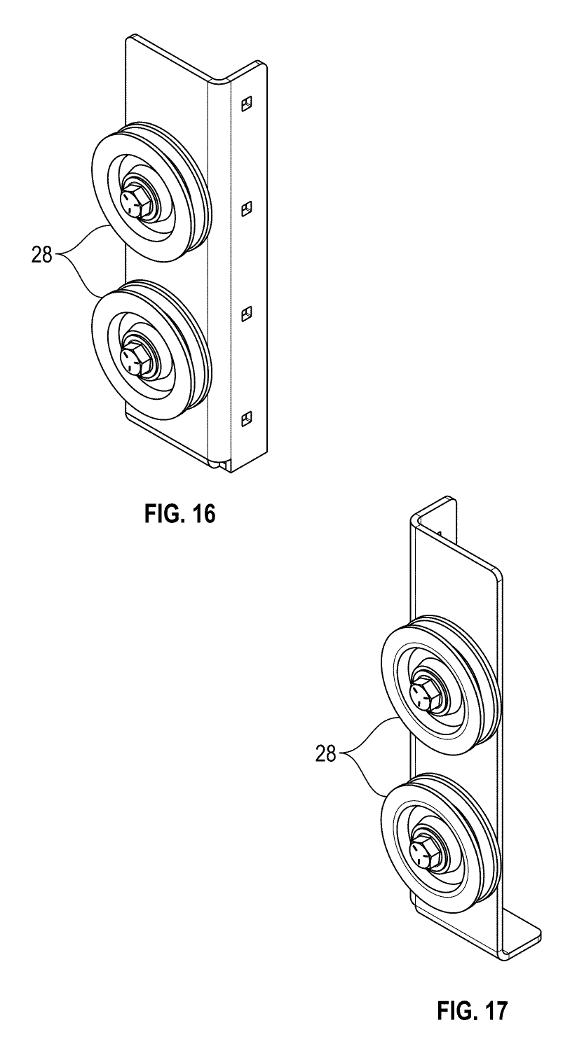

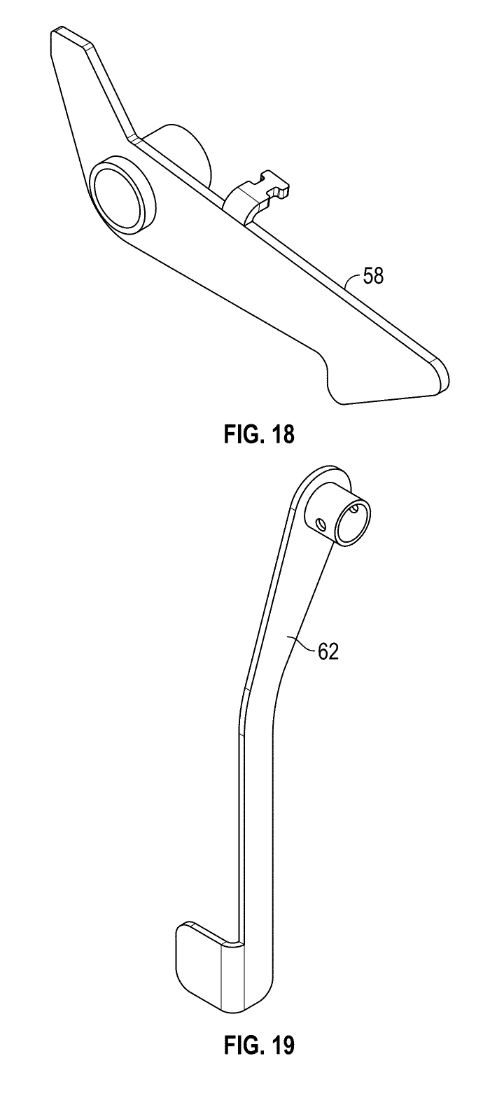

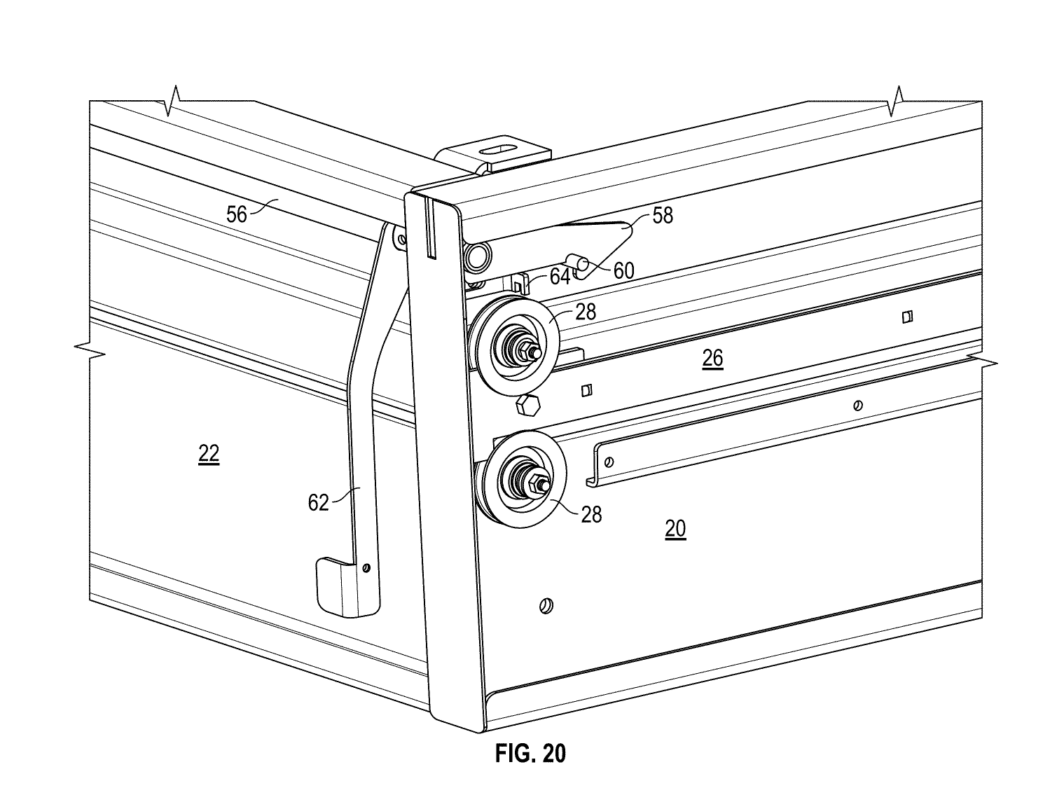

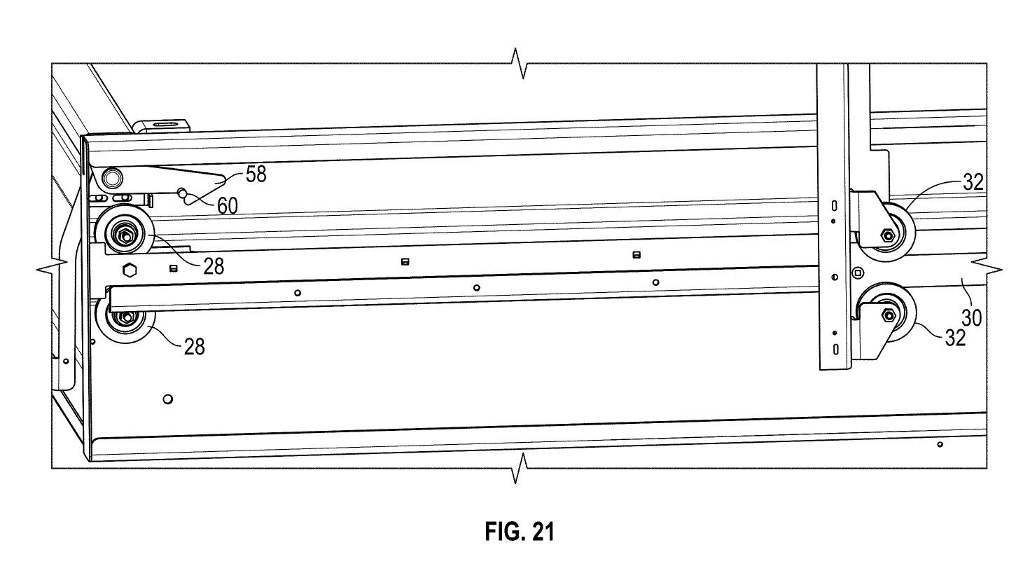

The enclosure of the present invention is generally designated in the drawings by the reference numeral 10. The enclosure includes a front section 12, a rear section 14, and may include one or more intermediate sections 16A, B. The rear section 14 is stationary, while the front section 12 and intermediate sections 16 are extendable and retractable between closed and open positions, as shown in FIGS. 1 and 5, respectively. Preferably, the sections nest or telescope with respect to one another, as best seen in FIGS. 5-7.

The enclosure 10 includes a base 18 with opposites sides 20, a front 22, and a rear 24. The sides 20 of the base 18 include rails or guide tracks 26 which extend the length of the base and which support interior rollers 28 on the front opposite sides of the sections 12 and 16A, and on the front and rear opposite sides of section 16B. Each intermediate section 16A, B also includes an exterior rail or guide track 30 on each side to support exterior rollers 32 on the rear opposite sides of each adjacent section 12 or 16A. The exterior rollers 32 can be enclosed in a housing 33 to keep the rollers 32 clean.

Each of the movable sections 12, 16 are formed by a U-shaped or arch-shaped frame 34, with a rigid skin 36 secured to the frame in any convenient manner, such as by rivets, screws, or bolts. The frame 34 and the skin 36 of the sections 12, 14, 16 define opposite side walls and the roof for the enclosure 10. The skin 36 is light weight, yet strong enough to withstand wind, hail, and snow loads.

The front section 12 and any intermediate sections 16 can be extended and retracted manually, for example by handles 38 (FIG. 5) secured to the front section 12. Alternatively, and preferably, the sections 12 and 16 are moved by a reversible electric motor 40 and a drive train. The motor 40 can be hardwired to an electrical power source, such as a battery 49 or can be powered by a solar panel 50. The motor 40 can be actuated by a switch or by a remote controller.

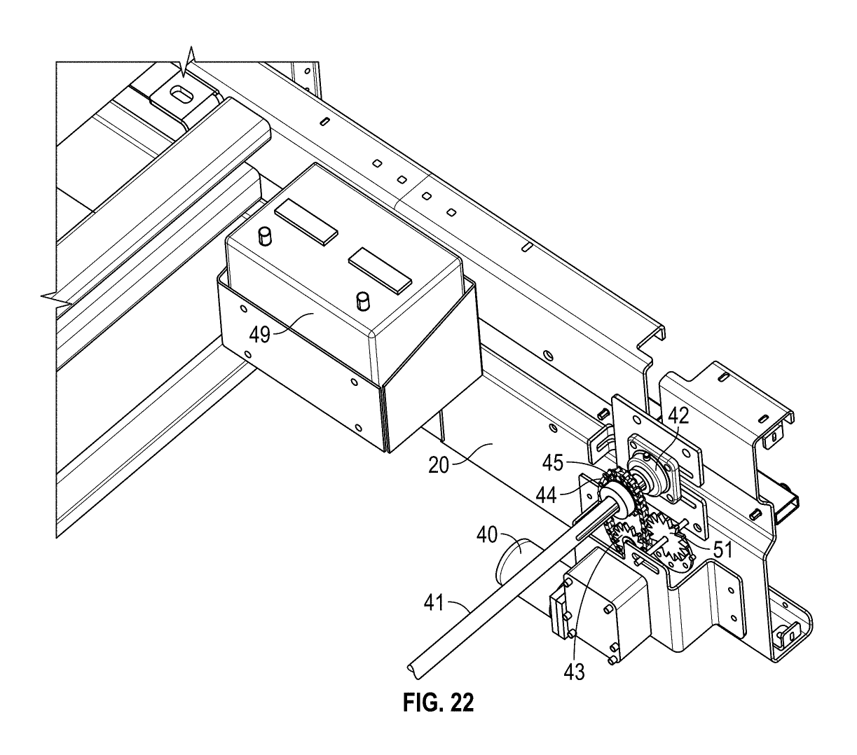

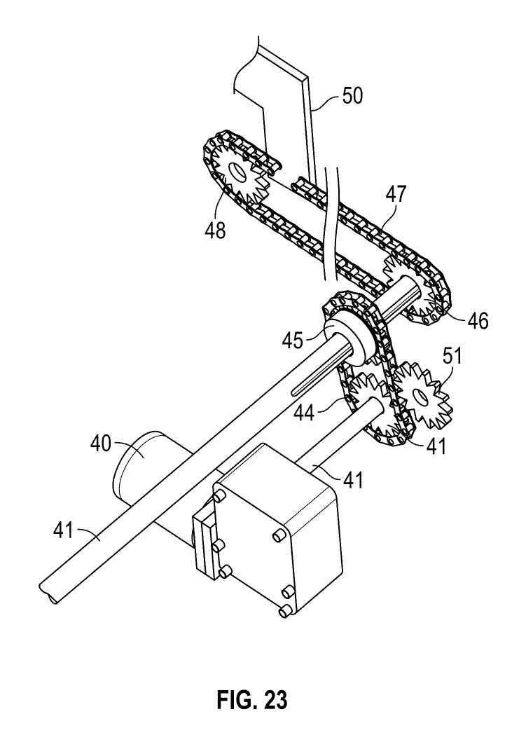

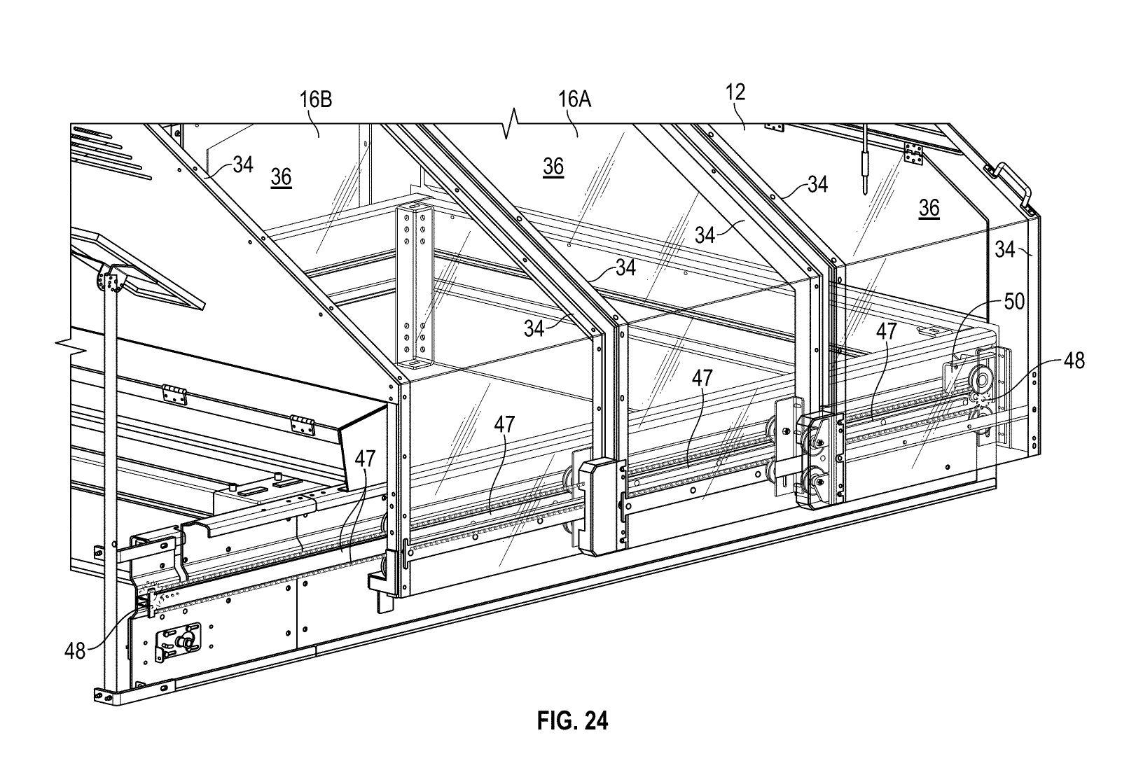

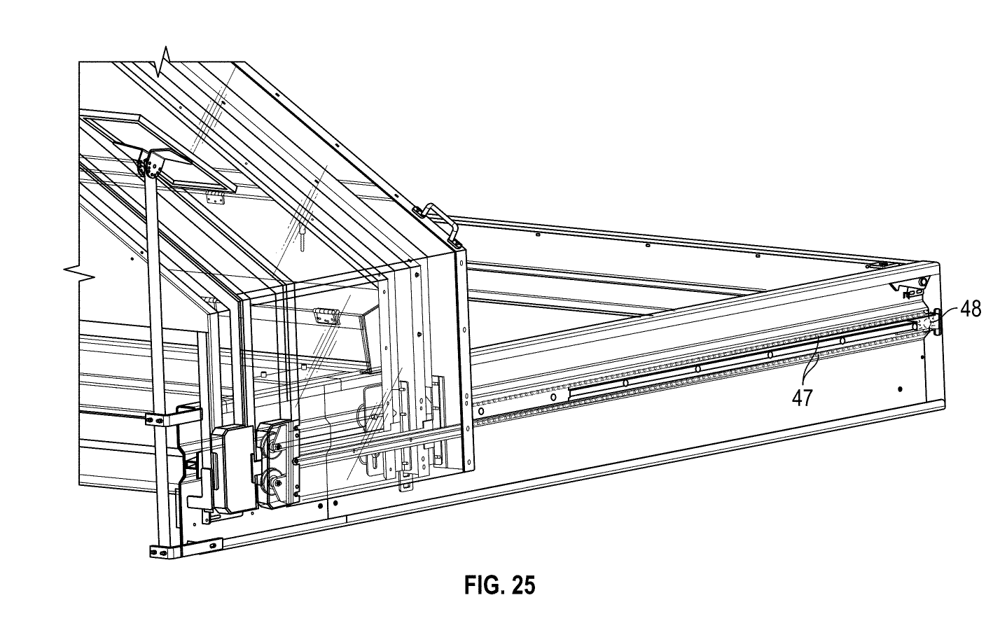

The motor 40 is mounted on the inside of the enclosure 10 on one side of the rear section 14, as seen in FIG. 22. An elongated shaft 41 extends between the opposite sides of the base 20 and is rotatably supported by bearings 42. The motor 40 has an output shaft with a drive sprocket 43. A roller chain 44 extends around the motor drive sprocket and a sprocket 45 fixed on the shaft 41, such that the shaft 41 rotates when the motor 40 is actuated. An adjustable tension sprocket 51 allows the tension of the chain 44 to be adjusted.

The shaft 41 has opposite ends extending through the opposite sides of the base 20, with a sprocket 46 fixed on each end of the shaft. An idler sprocket 48 is mounted on each side of the front of the base 20. A roller chain 47 extends around the sprockets 46, 49 on each side of the enclosure 10. The chain 47 is not endless, but has opposite ends fixed to a bracket 50 mounted on the inside of the front section 12 at the opposite sides of the section 12. Thus, there is a chain drive on each side of the enclosure 10.

When the motor 40 is actuated to rotate the drive shaft and sprocket in a counter clockwise direction, the chain 44 drives the sprocket 46, such that the chain 47 pulls the bracket 50 to retract the front section 12 as guided by the tracks 26 and 30 and the rollers 28 and 32. When the front section 12 engages the next adjacent section 16A, the sections 12 and 16A continue to retract, until section 16B is engaged, which then in turn also retracts, so as to open the enclosure 10. When the motor 40 is actuated to rotate in the clockwise direction, the chain 47 pulls the bracket 50 so as to sequentially extend the front section 12, the intermediate section 16A and then the intermediate section 16B. In a preferred embodiment, the full travel of the front section 12 is approximately 104 inches, though it is understood that this distance can be modified as needed to accommodate different sized enclosures 10.

The motorized enclosure 10 includes electronic circuitry for control of the motor 40. For example, the circuitry may include a switch to actuate the motor in opposite directions. The circuitry may also include one or more remote controllers, such as for the property owner or a truck driver to open and close the enclosure from a remote position. The circuitry may also include a timer such that if the enclosure remains open for a specified time, the motor is automatically actuated to close the enclosure. Such automatic closure of the enclosure 10 assures that the enclosure is normally closed, unless and until access inside the enclosure is needed.

It is understood that the drive train for the enclosure 10 may utilize other means, besides the chain and sprocket system shown in the drawings and described above. For example, the sections 12 and 16A, 16B can be sequentially moved hydraulically or pneumatically, or by electric linear actuators.

In a non-motorized embodiment, the enclosure 10 includes a latch and lock assembly so that the sections can be locked against movement, particularly from the closed position, to prevent unauthorized access into the enclosure. The latch and latch assembly includes a rod or bar 56 extending across the front 22 of the base 18. A latch hook 58 is provided on each end of the bar 56 and is adapted to releasably engage a pin 60 extending laterally and outwardly from each side 20 of the base 18. A latch release lever 62 is also mounted on the bar 56 at each of the opposite sides of the front 22 of the base 18. The release lever 62 on each end can be manually depressed to unlatch the hook 58, so that the front section 12 and the intermediate section 16 can be retracted to open the enclosure.

A pivotal lock 64 is also mounted on the bar 56 and is movable between a locked position engaging the latch hook 58 to preclude unlatching and an unlocked position which allows the latch hook 58 to unlatch.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. An enclosure for waste material, comprising:
a base having opposite sides and guide rails mounted to an exterior vertical surface of each side;
a front section having opposite sides extending downwardly beyond the opposite sides of the base and being rollably mounted to the guide rails;
a stationary rear section mounted on the base;
the front section being horizontally movable along the guide rails between an extended position covering the waste material and a retracted position uncovering the waste material.

2. (canceled)

3. The enclosure of claim 1 wherein the front and rear sections are telescoping.

4. The enclosure of claim 1 wherein the front and rear sections form opposite side walls and a roof for the enclosure.

5. The enclosure of claim 1 further comprising a drive system side of the enclosure for rolling the front section between the extended and retracted positions.

6. The enclosure of claim 5 wherein the drive system includes a controller.

7. The enclosure of claim 5 wherein the drive system includes a reversible electric motor.

8. The enclosure of claim 7 further comprising a remote controller to actuate the motor.

9. The enclosure of claim 1 further comprising at least one movable intermediate section between the front and rear sections and having opposite sides extending downwardly beyond the opposite sides of the base and being rollably mounted to the guide rails for movement between extended and retracted positions.

10. The enclosure of claim 1 wherein the front and rear sections each include a frame and a rigid skin attached to the frame.

11. A method of covering and uncovering material within an enclosure, the enclosure including a base with opposite sides, the method comprising:
rolling telescoping cover sections of an enclosure rearwardly on tracks residing on exterior vertical surfaces on the sides of the base whereby the base resides between opposite sides of the cover sections toward a stationary rear section of the enclosure to open the enclosure;
placing the material inside the enclosure; and
rolling the telescoping cover sections forwardly on the tracks so as to cover the material in the enclosure.

12-13. (canceled)

14. The method of claim 11 further comprising placing the material inside a dumpster located inside the enclosure.

15. The method of claim 11 wherein rolling of the cover sections is remotely controlled.

16. The method of claim 11 further comprising actuating a reversible motor to roll the cover sections forwardly and rearwardly.

17. The method of claim 11 wherein rolling of the cover sections is accomplished manually.

18. A waste material enclosure, comprising:
a base having, a front end, a back end, and opposite sides defining a width;
first and second arched members forming opposite walls and a roof for the enclosure, and each member spanning across the width of the base;
first and second arched members being retractable and extendable to open and close the enclosure;
each arched member being rollably supported on the base for longitudinal movement; and
the first arched member being rollably supported on the second arched member for longitudinal movement.

19. The waste material enclosure of claim 18 wherein each of the arched members has a frame with rigid skin attached to the frame.

20. The waste material enclosure of claim 18 wherein at least one of the arched members being rollably mounted on spaced apart rails for retraction and extension.

21. The waste material enclosure of claim 18 further comprising a reversible motor operatively connected to the at least one arched member for retraction and extension.

22. The waste material enclosure of claim 21 further comprising a remote controller to actuate the motor.

23. The enclosure of claim 1 wherein the sides of the base have front and rear ends and guide rails extending substantially between the front and rear ends.

24. The enclosure of claim 1 wherein the rear section resides behind the base.

25. The enclosure of claim 1 wherein the base sides have vertical wall surfaces and the guide rails are mounted on the vertical wall surfaces.

26. The enclosure of claim 9 wherein the intermediate section has opposite sides with tracks on each side, and the front section includes rollers engaging the tracks of the intermediate section.

27. The enclosure of claim 9 wherein the front section is rollably supported on the intermediate section and on the guide rails.

28. The method of claim 11 further comprising supporting one of the cover sections on the other cover section.

29. The enclosure of claim 1 wherein the front section has upper and lower wheels to track above and below the guide rails.

30. The enclosure of claim 9 wherein the intermediate section has upper and lower wheels to track above and below the guide rails.

31. The enclosure of claim 9 wherein the front section has rails along the opposite sides and the intermediate section has rollers to track along the rails.

32. The method of claim 11 further comprising roiling one of the telescoping sections along rails on an adjacent telescoping section.

33. The waste material enclosure of claim 18 further comprising a guide rail on each side of the base and upper and lower wheels on each member to track above and below each of the guide rails.

34. The waste material enclosure of claim 18 wherein one of the arched members has rails extending along opposite sides and the other of the arched members has rollers on opposite sides to track along the rails.
